(19) United States
(12) Patent Application Publication
(10) Pub. No.: US 2018/0365714 A1
(43) Pub. Date: Dec. 20, 2018

(54) PROMOTION EFFECTS DETERMINATION AT AN AGGREGATE LEVEL

(71) Applicant: ORACLE INTERNATIONAL CORPORATION, Redwood Shores, CA (US)

(72) Inventors: Ming LEI, Ellicott City, MD (US); Catalin POPESCU, Atlanta, GA (US)

(21) Appl. No.: 15/623,922

(22) Filed: Jun. 15, 2017

(51) Int. Cl. G06Q 30/02; G06N 3/08

(52) U.S. Cl. CPC G06Q 30/0202; G06N 3/08

(57) ABSTRACT

A system for forecasting sales of a retail item receives historical sales data of a class of a retail item, the historical sales data including past sales and promotions of the retail item across a plurality of past time periods. The system aggregates the historical sales to form a training dataset having a plurality of data points. The system randomly samples the training dataset to form a plurality of different training sets and a plurality of validation sets that correspond to the training sets, where each combination of a training set and a validation set forms all of the plurality of data points. The system trains multiple models using each training set, and using each corresponding validation set to validate each trained model and calculate an error. The system then calculates model weights for each model, outputs a model combination including for each model a forecast and a weight, and generates a forecast of future sales based on the model combination.

### FIELD

One embodiment is directed generally to a computer system, and in particular to a computer system that forecasts sales of retail items.

### BACKGROUND INFORMATION

Retailers frequently initiate promotions to boost sales and ultimately increase profit. There are many types of promotions that a retailer may initiate depending on the time frame and the type of retail items. Examples of possible promotions for retail items include temporary price cuts, rebates, advertisements in a newspaper, television or a website, or via email, coupons, special placement of items in a store, etc. In forecasting sales at a retailer, the promotions that will be in effect need to be accounted for.

In order to better manage the demand forecast and inventory, as well as plan future promotions to maximize profitability, retailers have to use the sales and promotion history to calculate accurate effects of each promotion. Further, the calculation needs to be done at a very granular level (e.g., at the item/store intersection) to account for different demographics and geographical locations. For example, a 12-pack of paper towel rolls may sell very well in a suburban store, while in an in-town store the demand may be much higher for a single or 2-pack. Further, typically a retailer has an extremely large number of item/store/week/promotions intersections that need to be planned. Therefore, it is essential that the promotion management is handled with minimal human interaction.

### SUMMARY

One embodiment is a system for forecasting sales of a retail item. The system receives historical sales data of a class of a retail item, the historical sales data including past sales and promotions of the retail item across a plurality of past time periods. The system aggregates the historical sales to form a training dataset having a plurality of data points. The system randomly samples the training dataset to form a plurality of different training sets and a plurality of validation sets that correspond to the training sets, where each combination of a training set and a validation set forms all of the plurality of data points. The system trains multiple models using each training set, and using each corresponding validation set to validate each trained model and calculate an error. The system then calculates model weights for each model, outputs a model combination including for each model a forecast and a weight, and generates a forecast of future sales based on the model combination.

### BRIEF DESCRIPTION OF THE DRAWINGS

FIG. 1 is a block diagram of a computer server/system in accordance with an embodiment of the present invention.

FIG. 2 is a flow diagram of the functionality of the promotion effects module of FIG. 1 when determining promotion effects at an aggregate level in accordance with one embodiment.

FIG. 3 illustrates six rounds of model estimation using the data points in accordance with one embodiment.

FIG. 4 illustrates a comparison of predictions using embodiments of the invention and actual sales.

### DETAILED DESCRIPTION

One embodiment estimates promotion effects at an item aggregate level using an entire data set available to a retailer by repeatedly sampling the data set, and then combining the outputs of all samples to generate a final estimate of the promotion effects. The estimate of the promotion effects is used to quantify the impact of the promotions on demand of retail items.

Sales forecasting methods can roughly be grouped into judgmental, extrapolation, and causal methods. Extrapolation methods use only the time series data of the activity itself to generate the forecast. Known particular techniques range from the simpler moving averages and exponential smoothing methods to the more complicated Box-Jenkins approach. While these known methods identify and extrapolate time series patterns of trend, seasonality and autocorrelation successfully, they do not take external factors such as price changes and promotion into account.

Vector Auto Regression (“VAR”) models extend the Box-Jenkins methods to include other variables, but their complexity makes estimation difficult. Causal forecasting involves building quantitative models using inputs representing the phenomena that are believed to be drivers of the outcome. The models can be as simple as linear regression model with promotion variables. A starting point is a regression model with promotion variables such as price cuts, rebates or advertisements. The idea is that model simplicity helps managers to understand and approve or guide modification of the models, and as they become more knowledgeable about a decision aid, they may be ready to implement more sophisticated and complex models.

Therefore, in general, the problem of estimating promotion effects on demand and sales for retail items can be approached two ways. In one method, the promotion effects can be estimated directly at the item/store level (e.g., for every individual stock keeping unit (“SKU”) at every individual retail store). However, the available demand and promotion data at this level is typically insufficient, making any estimation generally unstable, and the results generally inaccurate.

In another method, the promotion effects can be estimated at a more aggregate level, such as for all the retail stores in an entire region. The data at this level is generally much more stable and prevalent, allowing for a robust estimation of promotion effects. However, the richness of the data at this level is also a challenge. If all of the available data points are considered, the generating of an estimation using a computer can be very slow, due to the large amount of data that needs to be processed, and the output can be unduly influenced by outliers. On the other hand, if only data points that pass some pre-defined criteria are included (i.e., using data filtering), the processing speed is increased, but the output is biased and dependent on the pre-defined criteria.

For example, some forecasting systems pool the data from various SKUs or categories, so that some categories with very little data are excluded. This causes the forecasting for those categories to be inaccurate. Further examples of filtering including making corrections in the data to account for unusual events such as: (1) Weather-related; (2) Inflated demand (e.g., people stocking up on water before a storm); (3) Low demand (e.g., a store is closed during a hurricane resulting in lower than usual demand); (4) Supply chain (e.g., out of stock situations causing merchandise to sell below usual levels); and (5) Hardware/IT (e.g., computer hardware or software failures can result in incorrect capturing of demand). All of the above need to be caught and either corrected for, or made sure to be excluded from the analysis.

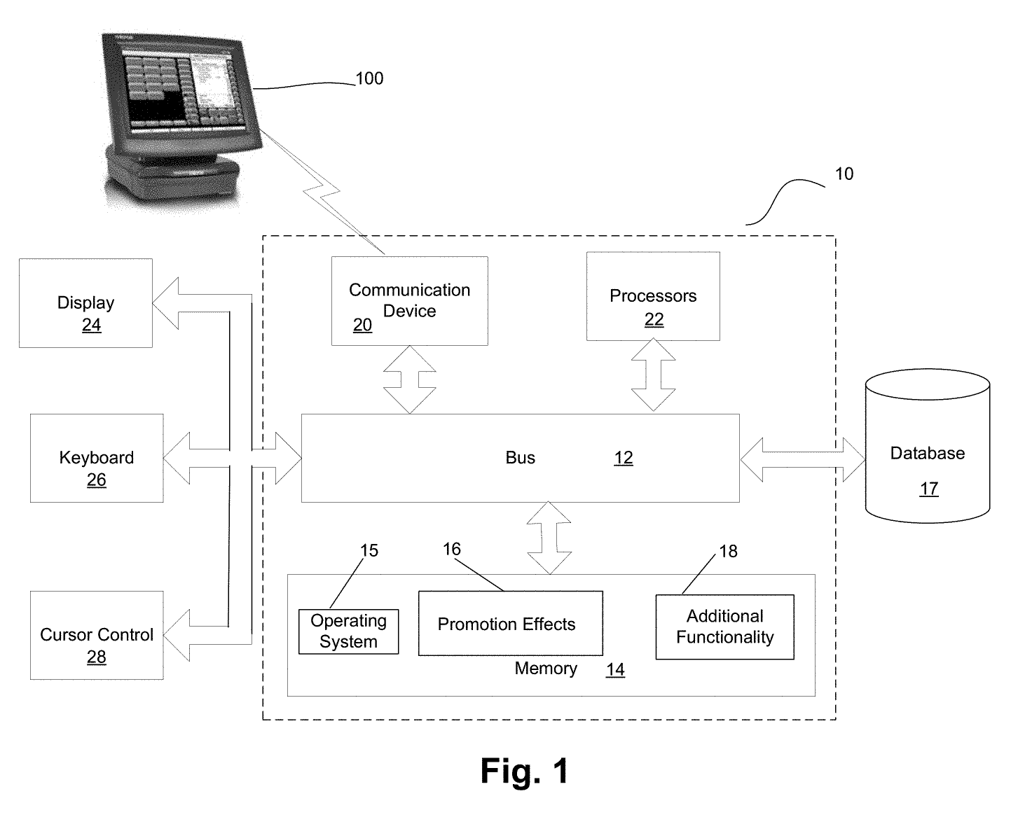

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a server, system 10 may need to include a processor and memory, but may not include one or more of the other components shown in FIG. 1, such as a keyboard or display.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a promotion effects module 16 that determines promotion effects at an aggregate level, and all other functionality disclosed herein. System 10 can be part of a larger system. Therefore, system 10 can include one or more additional functional modules 18 to include the additional functionality, such as a retail management system (e.g., the “Oracle Retail Demand Forecasting System” or the “Oracle Retail Advanced Science Engine” (“ORASE”) from Oracle Corp.) or an enterprise resource planning (“ERP”) system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 100 generates the transactional data and historical sales data (e.g., data concerning transactions of each item/SKU at each retail store) used to estimate the impact of promotion effects. POS terminal 100 itself can include additional processing functionality to estimate the impact of the promotion effects in accordance with one embodiment.

In one embodiment, system 10 is a computing/data processing system including an application or collection of distributed applications for enterprise organizations. The applications and computing system 10 may be configured to operate with or be implemented as a cloud-based networking system, a software-as-a-service (“SaaS”) architecture, or other type of computing solution.

As disclosed above, known methods of estimating promotion effects at the aggregate level is done either using filtered data, or using the entire data set. Each approach has its merits and its shortcomings. Estimating promotion effects using the entire data set takes into account all available data, but due to the extremely large amount of data needed to be processed, the estimating takes an undue amount of time to be executed by known computer systems. Using only a subset of the data runs faster by reducing the amount of required processing, but includes a bias that is introduced by whatever method/selection is used to filter the data set.

In contrast, embodiments of the invention use the entire data set, therefore eliminating bias, by sampling the data set repeatedly, and combining the outputs of all samples to create the final estimate. Embodiments provide a machine learning technique that improves the stability and accuracy of other machine learning algorithms used for classification. Embodiments use the classification to quantify the impact of promotions on demand.

Embodiments use the determination of promotion effects in order to estimate a sales forecast. The forecast is an important driver of the supply chain. If a forecast is inaccurate, allocation and replenishment perform poorly, resulting in financial loss for the retailer. Improvements in forecast accuracy for promoted items may be achieved by the embodiments disclosed herein. Further, a better understanding of the impact a promotion has on demand may be achieved. This helps the retailer to more effectively plan promotions with respect to channel, pricing, and customer segments, for example.

Embodiments are disclosed from the perspective that, for an item (e.g., a retail item represented by an SKU) sold at a location (e.g., a retail location), the item may be promoted in various ways at various times (i.e., pre-defined retail periods, such as a day, week, month, year, etc.). A retail calendar has many retail periods (e.g., weeks) that are organized in a particular manner (e.g., four (4) thirteen (13) week quarters) over a typical calendar year. A retail period may occur in the past or in the future. Historical sales/performance data may include, for example, a number of units of an item sold in each of a plurality of past retail periods as well as associated promotion data (i.e., for each retail period, which promotions were in effect for that period).

As disclosed below, embodiments use one or more models that are trained using different training sets, all based on the same dataset, but all different. Models used in some embodiments can include linear regression models or machine learning techniques, such as decision or regression trees, Support Vector Machines (“SVM”) or neural networks.

In connection with linear regression models, the search for a linear relationship between an output variable and multiple input variables has resulted in stepwise selection of input variables in a regression setting. In some embodiments, the goal is to build a function that expresses the output variable as a linear function of the input variables plus a constant. Two general approaches in stepwise regression are forward and backward selection.

In forward selection, variables are introduced one at a time based on their contribution to the model according to a pre-determined criterion. In backward selection, all input variables are built into the model to begin with, and then input variables are removed from the regression equation if they are judged as not contributing to the model, again based on a pre-determined criterion.

In machine learning, SVMs are supervised learning models with associated learning algorithms that analyze data used for classification and regression analysis. Given a set of training examples, each marked as belonging to one or the other of two categories, an SVM training algorithm builds a model that assigns new examples to one category or the other, making it a non-probabilistic binary linear classifier. An SVM model is a representation of the examples as points in space, mapped so that the examples of the separate categories are divided by a clear gap that is as wide as possible. New examples are then mapped into that same space and predicted to belong to a category based on which side of the gap they fall.

In addition to classification, SVMs have been successfully applied in sales or demand forecasting, being able to process common metrics, such as sales, as well as price, promotions, external factors such as weather and demographic information.

SVM and its regression version of Support Vector Regression (“SVR”) implicitly map instances into a higher dimensional feature space using kernel functions. In its most basic form, SVR ideally seeks to identify a linear function in this space that is within a distance to the mapped output points. This “soft margin formulation” allows and penalizes deviations beyond the pre-determined distance, and minimizes the sum of violations along with the norm of the vector that identifies the linear relationship

A regression tree technique partitions the data into smaller subsets in a decision tree format and fits a linear regression model at every leaf that is used to predict the outcome. Alternative model tree approaches differ from each other mainly in the choice criteria of the input variable to be branched on, split criteria used, and the models constructed at every leaf of the tree. While trees are transparent in the sense that the prediction for a particular case can be traced back to the conditions in the tree and the regression function that is applicable for cases that satisfy those conditions, trees with many layers are not easy to interpret in a generalizable manner.

An Artificial Neural Network (“ANN”) is an information processing paradigm that is inspired by the way biological nervous systems, such as the brain, process information. The key element of this model is the novel structure of the information processing system. It is composed of a large number of highly interconnected processing elements (i.e., neurons) working in unison to solve specific problems. ANNs learn by example. An ANN is configured for a specific application, such as pattern recognition or data classification, through a learning process. Learning in biological systems involves adjustments to the synaptic connections that exist between the neurons. This is true of ANNs as well. Since neural networks are best at identifying patterns or trends in data, they are well suited for prediction or forecasting needs.

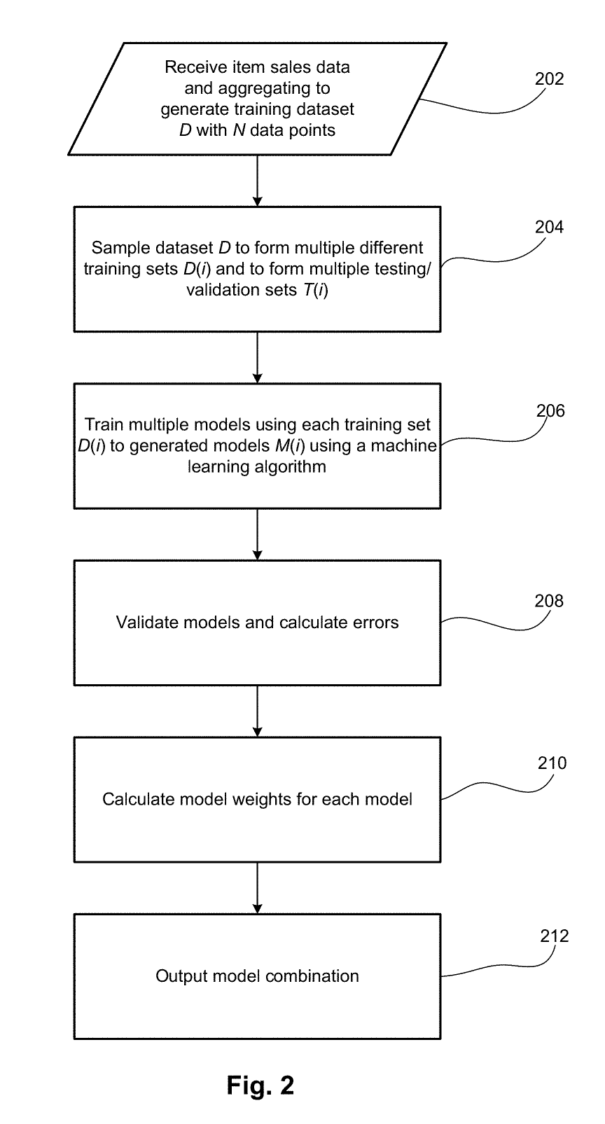

FIG. 2 is a flow diagram of the functionality of promotion effects module 16 of FIG. 1 when determining promotion effects at an aggregate level in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, historical item sales data is received for all items for all stores for a particular class/category of products. For example, the class/category can be “yogurt”, “coffee” or “milk.” Each class has one or more subclasses, all the way down to the SKU or Universal Product Code (“UPC”) level, which would be each individual item for sale, For example, for the class of yogurt, a sub-class could be each brand of yogurt, and further sub-classes could be flavor, size, type (e.g., Greek or regular), down to an SKU which would correspond to every individual different type of yogurt item sold. Each SKU or UPC would be considered a discrete data point or discrete item.

Historical sales and performance data may include, for example, data representing past sales and promotions of an item across a plurality of past retail periods. The historical performance data may be segmented into retail periods of past weeks, with each past week having numerical values assigned to it to indicate the number of items sold for that week. The historical performance data may also include numerical values representing price discounts and values of other promotion components across the retail periods, in accordance with one embodiment. The historical performance data for an item may be accessed via network communications, in accordance with one embodiment, including being accessed from each POS terminal 100 at each retail store and/or accessed from database 17.

The historical performance data includes sales data associated with the plurality of promotion components across a plurality of time periods (e.g., weeks). Examples of promotion components include, but are not limited to, a price discount component, a television advertisement component, a radio advertisement component, a newspaper advertisement component, an email advertisement component, an internet advertisement component, and an in-store advertisement component.

All the valid data points are pooled to form a training dataset D with N data points at a given aggregated level. Aggregate levels are intersections higher than SKU/store/week at which the data is pooled. An example of an aggregate level is subclass/store. The data available at this level is determined by all SKUs in a particular subclass. The aggregate levels in embodiments are typically picked to be low enough to capture the low level details of the merchandise, but also high enough that the data pool is rich enough for a robust estimation of the promotion effects.

For example, if there are 50 items in the subclass that have been selling on average for approximately a year (i.e., 52 weeks), and there are 50 retail stores in a chain, then:

N=50*52*50=130,000 data points

As a result of 202, a training dataset D are formed with N data points. In this example, the given aggregate level is subclass/store.

At 204, dataset D is sampled multiple times to form multiple different training sets D(i). Embodiments generate m new training sets D(i), each of size n′ (e.g., 80% of N) by randomly sampling from D uniformly and with replacement. Sampling with replacement is used to find probability with replacement. Specifically, determining the probability of some event where there is a number of data points, balls, cards or other objects, and each item is replaced every time one is chosen. For example, when sampling two with replacement, the two sample values are independent. Therefore, what is replaced by the first one does not affect what is replaced on the second. Mathematically, this means that the covariance between the two is zero.

The data points not used (i.e., that do not form part of the sampled set) for training (N−n′) are used for validation as a validation/testing set T(i). For example, in one embodiment, five training sets are generated. Each training set has (130,000)*(0.8)=104,000 data points and each testing/validation set includes the 26,000 remaining data points. Each training set differs due to the random sampling.

At 206, for each training set D(i) at 204, one of multiple possible different machine algorithms are run to produce/train models. In one embodiment, for each training set D(i), one of the following machine learning algorithms are used to produce the model M(i): linear regression, Support Vector Machine (“SVM”), and Artificial Neural Networks (“ANN”). A machine learning algorithm, in general, can learn from and make predictions on data. A machine learning algorithm operates by building a model from an example training set of input observations in order to make data-driven predictions or decisions expressed as outputs, rather than following strictly static program instructions.

Training a model using a machine learning algorithm, in general, is a way to describe how the output of the model will be calculated based on the input feature set. For example, for a linear regression model, the forecast can be modeled as follows: forecast=base demand*seasonality*promotion 1*promotion 2*promotion effect 10. For different training methods, the output will be different. For example: (1) for linear regression, the training will produce the estimations for seasonality, promotion effect 1 . . . promotion effect 10; (2) for the SVM, the training will produce the “support vector” which is the set of the input data points associated with some weight; (3) for the ANN, the training output will be the final activation function and corresponding weight for each nodes.

At 208, each model is validated and errors are determined using the test set. For each model M(i), embodiments apply the test set T(i) to predict the results and calculate the root-mean-square error RMSE(i). For example, for a test data set i, in which there are 10 data points x1, . . . x10, embodiments predict the output of these 10 points based on the trained model. If the output is P1, . . . P10, then the RMSE is calculated as follows:

$$rmse = \sqrt{( {\sum }_{n = 1}^{10} {( xi - pi )}^{2} ) ) / 10}$$

At 210, for each model, model weights are calculated. In one embodiment, for each model M(i), its weight w(i) is determined as follows:

$$w ( i ) = \frac{1}{1 + RMSE ( i )}$$

Embodiments then determine the sum of the w(i)'s as follows:

S=sum(w(i))

Finally, embodiments normalize the weight for each w(i) as follows:

$${w}^{′} ( i ) = \frac{w ( i )}{S}$$

At 212, the model combination is output. To forecast future demand, for each data point x, M(i) is iteratively applied to the input to produce the final results y as follows:

y=sum(f(M(i),x)*w′(i))

where y is the forecasted demand, and f is the function to create the forecast, corresponding to the model. For instance consider three models. For a given point x, the models yield a forecast and weights given in the below table:

| Model | Forecast | Weight |
|---|---|---|
| Model 1 | 4 | 0.5 |
| Model 2 | 4.5 | 0.3 |
| Model 3 | 3.9 | 0.2 |

The final forecasted demand is calculated as:

y=4*0.5+4.5*0.3+3.9*0.2=4.13

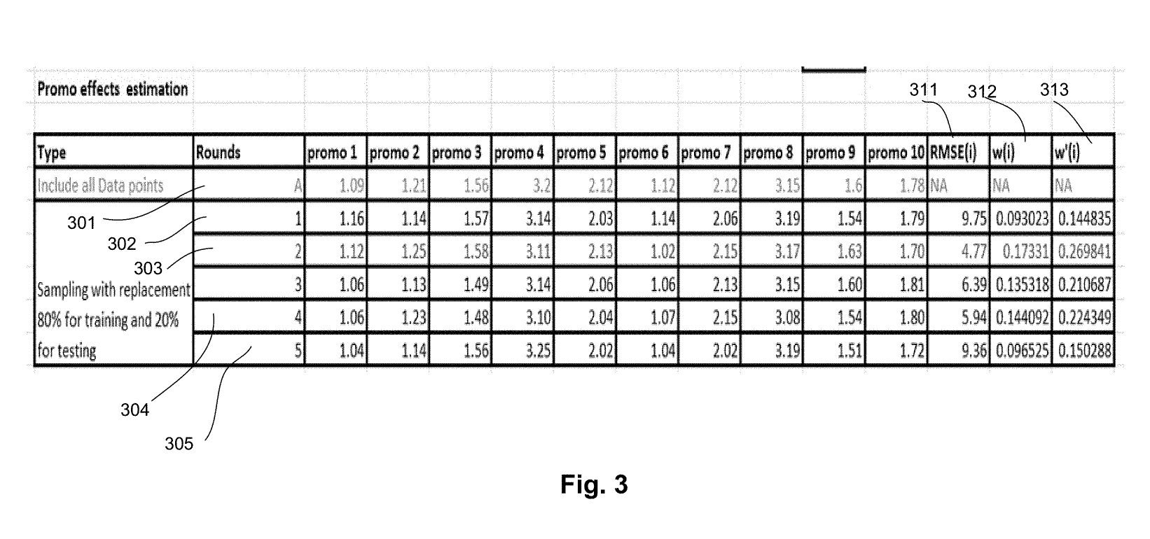

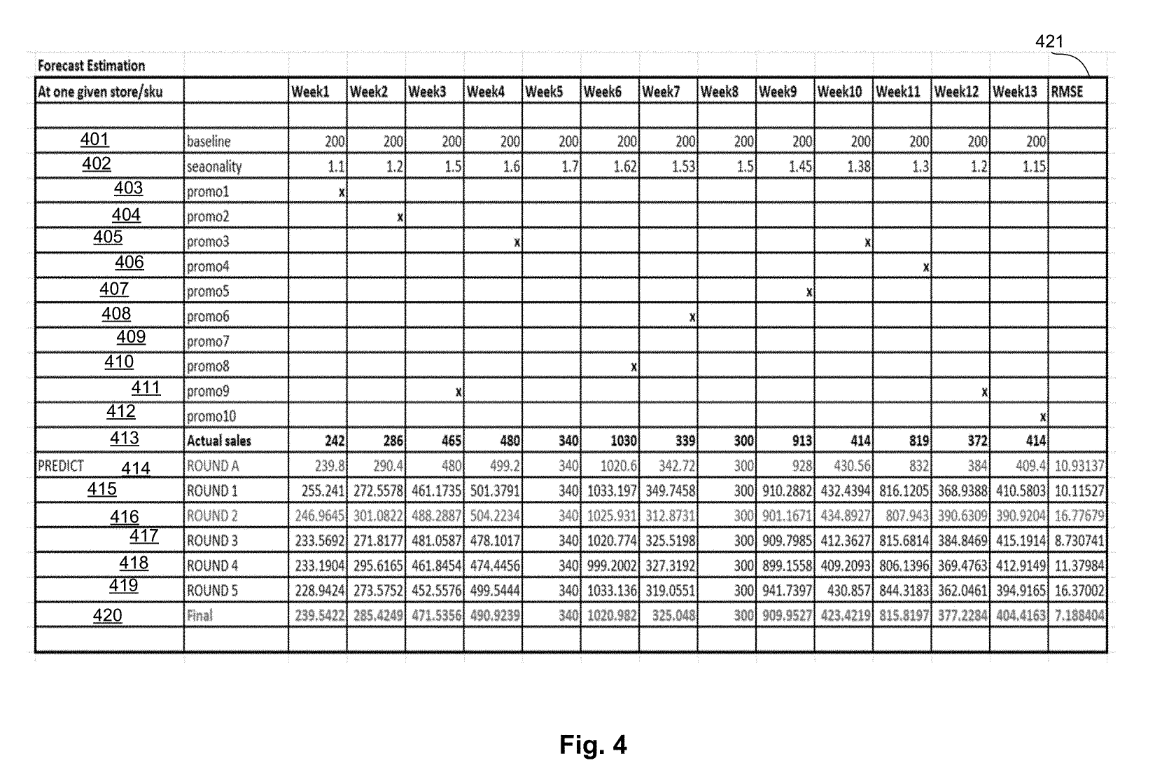

FIGS. 3 and 4 illustrate an example of determining promotion effects at an aggregate level in accordance with one embodiment. In the example of FIGS. 3 and 4, assume for a retailer “A” there are 2 years of history of the yogurt category in the Atlanta, Ga. area. Assume there are 20 retail stores in the Atlanta area, and each store includes approximately 100 different yogurt UPC/SKUs.

In accordance with 202 above, there is a total of 20100104=2,080,000 data points for an item/store/week sales aggregate level in this simplified example that form the training dataset D, where 20 is the number of retail stores, 100 is the number of SKUs, and 104 is the number of weeks for the two year historical sales period.

It is also assumed that there are 10 different types of promotions that are offered by the retailer. The promotions are referred to as “promo 1”, “promo 2”, “promo 3” . . . “promo 10”. In this example, the demand model is as follows:

sales=(base demand)*(seasonality)*(promo 1 effect)*(promo 2 effect)* . . . (promo 10 effect)

The base demand can be calculated at an item/store level using known methods, such as moving average, simple exponential smoothing, etc.

The seasonality can be calculated at the category/region level using known methods, such as additive and multiplicative winters exponential smoothing models. The challenge is to estimate the ten promotion effects (i.e., estimate the effects of each promotion on the sales forecast during each sales period that the promotion is in effect). In this example, because there is only two years of sales history, estimating the promotion effects at an item/store level is difficult using known estimating methods.

FIG. 3 illustrates six rounds of model estimation using the data points in accordance with one embodiment. For each round, the promotion effects for each promotion 1-10 is determined using linear regression. The same type of algorithm used in each round. For example, each round can use linear regression, SVM, neural networks, etc. After each round a set of parameters are generated that describe the training set used. The set of parameters is what is referred to as the “model.” Therefore, in the example of FIG. 3, six models are obtained based on six rounds.

In round A (row 301) all available data points are used for purposes of comparison with the inventive determinations. For rounds 1-5 (rows 302-306), sampling data is used to do the estimation (per 204 of FIG. 2) and the remaining testing data is used to test/validate the model (per 208 of FIG. 2). In one embodiment, the sampling data is 80% of the data points, and the testing data is the remaining 20% of the data.

In the example shown in FIG. 3, linear regression is used for training. Since each round uses a different training data set, the estimated effects will be different for each round. The promotion effects are product/location specific, but not time period specific. The same model and methodology is used for each round.

For each of training/testing, the RMSE in col. 311 is calculated based on the testing data (per 208 of FIG. 2) and the corresponding weight w(i) and normalized weight w′(i) of each round is calculated in columns 312, 313 as disclosed above.

FIG. 4 illustrates a comparison of predictions using embodiments of the invention and actual sales.

For each week during a 13 week sales period, and for a given store/SKU (e.g., a specific type of yogurt sold at a specific retail store), row 401 provides a baseline demand, row 402 provides seasonality, and rows 402-412 provide an indication (as indicated by an “X”), for each promotion, whether that promotion was active during the corresponding week. Row 413 indicates actual sales during the corresponding time period.

As for the prediction of promotion effects, row 414 indicates the predictions of sales for each week from Round A, in which all data points are used using known methods of using all available data. Rows 415-419 indicates the predictions/estimated using each of Rounds 1-5 for each time period (using embodiments of the present invention), and row 420 is the average prediction from Rounds 1-5. Column 421 uses RMSE to show that the approach using embodiments of the invention achieves the best performance (i.e., row 420 in accordance with embodiments of the invention has a smaller RMSE than row 420 which uses known methods that use the entire data set without sampling).

Instead of estimating promotion impact working with a trimmed down data, which introduces bias, embodiments utilize the richness of the entire data set, but uses sampling to reduce the necessary processing power. Embodiments are fully automated and can be adjusted to balance performance and accuracy. Further, embodiments provide an improvement in forecast accuracy for promoted items. The forecast is one of the most important drivers of the supply chain. If it is inaccurate, allocation and replenishment perform poorly, resulting in financial loss for the company.

In general, shoppers pay special attention to promoted items. If the promotion was poorly planned, and the forecast is too high, items will remain unsold, and they need to be sold at a discount, or wastage increases. In both cases, profitability goes down. If the forecast is low, demand is not satisfied and retailers experience lost sales and low client satisfaction. Both have negative impact on the revenue. Embodiments avoid lost sales or unnecessary markdowns by balancing accuracy and reliability of the promotion/sales forecast.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of forecasting sales of a retail item, the method comprising:
receiving historical sales data of a class of a retail item, the historical sales data comprising past sales and promotions of the retail item across a plurality of past time periods;
aggregating the historical sales to form a training dataset having a plurality of data points;
randomly sampling the training dataset to form a plurality of different training sets and a plurality of validation sets that correspond to the training sets, wherein each combination of a training set and a validation set forms all of the plurality of data points;
training multiple models using each training set, and using each corresponding validation set to validate each trained model and calculate an error;
calculating model weights for each model;
outputting a model combination comprising for each model a forecast and a weight; and
generating a forecast of future sales based on the model combination.

2. The method of claim 1, wherein the training multiple models comprises using a machine learning algorithm for the training.

3. The method of claim 2, wherein the machine learning algorithm comprises one of linear regression, Support Vector Machine, or Artificial Neural Networks.

4. The method of claim 1, wherein the historical data comprises data for multiple retail stores and multiple stock keeping units that belong to a subclass over multiple time periods, wherein the aggregating comprises a subclass level.

5. The method of claim 1, wherein the randomly sampling comprises sampling with replacement.

6. The method of claim 1, wherein the error is a root-mean-square error (RMSE) and for each model of each training set i, the calculating model weights w(i) comprises:
$$w ( i ) = \frac{1}{1 + RMSE ( i )} .$$

7. The method of claim 6, further comprising:
determining a sum S of the model weights w(i) comprising S=sum(w(i)); and
normalizing a weight w′(i) for each w(i) comprising
$${w}^{′} ( i ) = \frac{w ( i )}{s} .$$

8. The method of claim 7, wherein the generating the forecast of future sales y using each model M(i) comprises:
y=sum(f(M(i), x)*w′(i)), wherein f comprises the forecast for each model.

9. A computer-readable medium having instructions stored thereon that, when executed by a processor, cause the processor to forecast sales of a retail item, the forecasting comprising:
receiving historical sales data of a class of a retail item, the historical sales data comprising past sales and promotions of the retail item across a plurality of past time periods;
aggregating the historical sales to form a training dataset having a plurality of data points;
randomly sampling the training dataset to form a plurality of different training sets and a plurality of validation sets that correspond to the training sets, wherein each combination of a training set and a validation set forms all of the plurality of data points;
training multiple models using each training set, and using each corresponding validation set to validate each trained model and calculate an error;
calculating model weights for each model;
outputting a model combination comprising for each model a forecast and a weight; and
generating a forecast of future sales based on the model combination.

10. The computer-readable medium of claim 9, wherein the training multiple models comprises using a machine learning algorithm for the training.

11. The computer-readable medium of claim 10, wherein the machine learning algorithm comprises one of linear regression, Support Vector Machine, or Artificial Neural Networks.

12. The computer-readable medium of claim 9, wherein the historical data comprises data for multiple retail stores and multiple stock keeping units that belong to a subclass over multiple time periods, wherein the aggregating comprises a subclass level.

13. The computer-readable medium of claim 9, wherein the randomly sampling comprises sampling with replacement.

14. The computer-readable medium of claim 9, wherein the error is a root-mean-square error (RMSE) and for each model of each training set i, the calculating model weights w(i) comprises:
$$w ( i ) = \frac{1}{1 + RMSE ( i )} .$$

15. The computer-readable medium of claim 14, further comprising:
determining a sum S of the model weights w(i) comprising S=sum(w(i)); and
normalizing a weight w′(i) for each w(i) comprising
$${w}^{′} ( i ) = \frac{w ( i )}{S} .$$

16. The computer-readable medium of claim 15, wherein the generating the forecast of future sales y using each model M(i) comprises:
y=sum(f(M(i), x)*W(i)), wherein f comprises the forecast for each model.

17. A retail sales forecasting system comprising:
a processor coupled to a storage device that implements promotions effect module comprising;
receiving from a point of sale terminal historical sales data of a class of a retail item, the historical sales data comprising past sales and promotions of the retail item across a plurality of past time periods;
aggregating the historical sales to form a training dataset having a plurality of data points;
randomly sampling the training dataset to form a plurality of different training sets and a plurality of validation sets that correspond to the training sets, wherein each combination of a training set and a validation set forms all of the plurality of data points;
training multiple models using each training set, and using each corresponding validation set to validate each trained model and calculate an error;
calculating model weights for each model;
outputting a model combination comprising for each model a forecast and a weight; and
generating a forecast of future sales based on the model combination.

18. The retail sales forecasting system of claim 17, wherein the training multiple models comprises using a machine learning algorithm for the training.

19. The retail sales forecasting system of claim 18, wherein the machine learning algorithm comprises one of linear regression, Support Vector Machine, or Artificial Neural Networks.

20. The retail sales forecasting system of claim 17, wherein the historical data comprises data for multiple retail stores and multiple stock keeping units that belong to a subclass over multiple time periods, wherein the aggregating comprises a subclass level.
